(19) United States
(12) Patent Application Publication
(10) Pub. No.: US 2006/0103159 A1
(43) Pub. Date: May 18, 2006

(54) Underbed box for trucks

(75) Inventors: Atul Saigal, Algonquin, IL (US); Barry Bidinger, Palatine, IL (US); Tom Schwalie, Crystal Lake, IL (US); Bob Bergum, Woodstock, IL (US)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: Knaack Manufacturing

(21) Appl. No.: 10/990,085

(22) Filed: Nov. 16, 2004

(51) Int. Cl. B60R 9/02

(52) U.S. Cl. 296/37.6

(57) ABSTRACT

An underbed box for mounting to vehicles, more particularly for mounting to the underbed of trucks. The box has a door with an adjustable opening that can be opened at any angle between 0° and 95°. The door has two chains that can be removed to allow the door to be opened at any angle between 0° to 180°, thereby improving access to the interior of the box. The box is constructed from steel and the door is made of aluminum, welded to an aluminum hinge, and bolted to the walls of the box for superior corrosion resistance. Thus, the box is strong enough to withstand extreme working conditions while simultaneously providing corrosion resistance.

### BACKGROUND OF THE INVENTION

1. Field of the Invention

This invention relates to the field of storage containers for vehicles. More particularly, the invention relates to a storage box for attaching to the underbed of a truck for storing a variety of equipment during transport.

2. Description of Related Art

The prior art reveals a variety of storage containers for vehicles, including underbed boxes for trucks. These boxes are mounted to the underbed of trucks and used to store various tools or other equipment during transport. All of the known boxes, however, suffer from common shortcomings.

Since the boxes are located on the underbed of a truck and typically open to only a specified amount, it can be difficult to access the interior of the boxes in order to load or retrieve the contents. Further, there are occasions that the set openings of the boxes do not accommodate the size or orientation of the items to be stored. None of the known boxes has an adjustable opening to facilitate the loading and retrieval of the box contents.

Another shortcoming of the prior art boxes is related to the material of construction. Most known boxes are made of either steel or aluminum. Steel is very durable but highly susceptible to corrosion. Aluminum, conversely, effectively guards against corrosion but is a very soft and fragile metal, and therefore can be adversely affected by the roughness of the ride. None of the known boxes is made of a material sturdy enough to endure the roughness of the ride while underneath the truck, while also being capable of upstanding inclement weather that may lead to corrosion.

Accordingly, there is a need in the prior art for an underbed box that has an adjustable opening in order to improve access to the contents of the box. There is a further need for an underbed box that is constructed of a material that is strong and durable to endure the roughness of the ride while also successfully protecting against corrosion resulting from the elements.

### SUMMARY OF THE INVENTION

The present invention meets the shortcomings of the prior art by providing an underbed box that has an adjustable opening to improve access to its contents. The box includes adjustable and removable chains that connect the door to the box, and allow the door to be opened to any angle between 0° and 180°. This feature provides the user with improved access to the contents of the box while it is still attached to the truck.

The present invention further meets the needs of the prior art by providing a box made of a combination of steel and aluminum. The walls of the box are made of steel so they are very strong and durable. The door of the box is constructed of aluminum, welded to an aluminum panel hinge, and then bolted to the steel walls for superior corrosion resistance. This combination of materials of construction ensures that the box can withstand any type of extreme situation resulting from the working environment of the box.

### BRIEF DESCRIPTION OF THE DRAWINGS

FIG. 1 is a perspective view of an underbed box of the present invention mounted to a truck bed frame.

FIG. 2 is a perspective view of the box of FIG. 1, with its door in the open position.

FIG. 3 is a front view of the “D”-shaped handle located on the outside of the door.

FIG. 4 is a detailed perspective view of the three-point latch mechanism shown in FIG. 2.

FIG. 5 is a detailed view of the chain support mounted to the inside of the box of FIG. 2.

FIG. 6 is a detailed view of the chain support mounted to the inside of the door of the box of FIG. 2.

### DETAILED DESCRIPTION OF THE PREFERRED EMBODIMENTS

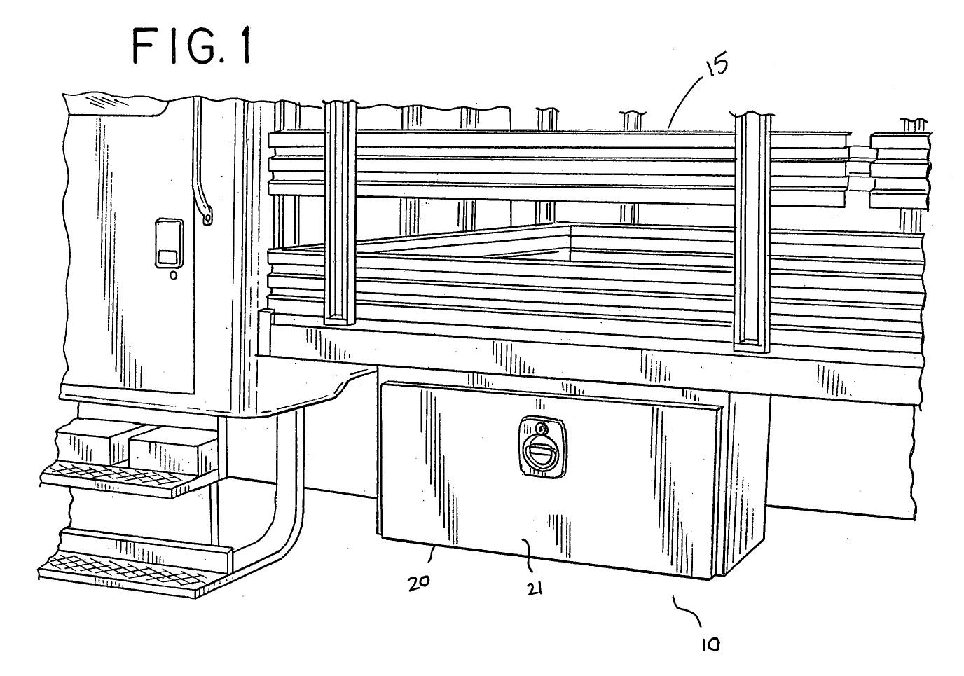

With reference to FIG. 1, underbed box 10 is mounted onto the underside of a truck 15 and may be used to transport a variety of equipment. Although a specific truck is depicted in the figure, the box 10 may be mounted onto a variety of trucks, from 18-wheelers to pick-ups. The box 10 may be welded onto the underbed of the truck or it may be mounted by bolts and brackets.

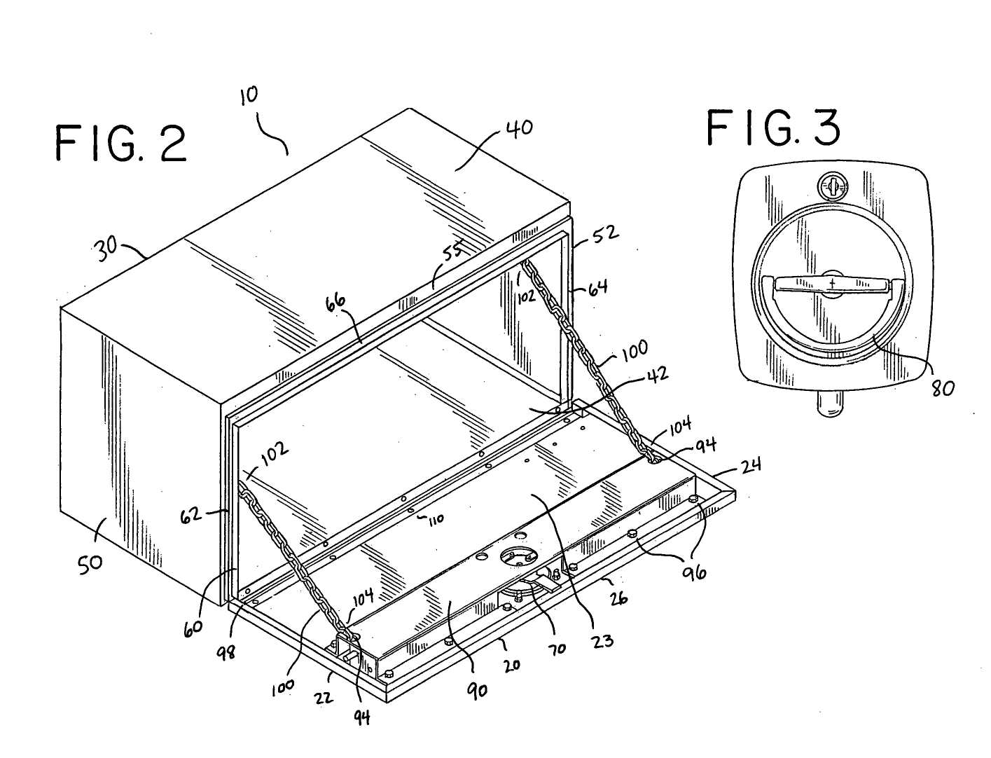

Referring to FIG. 2, underbed box 10 includes a door 20, a first wall 30 located opposite the door 20, second and third walls 40, 42 positioned between the door 20 and the first wall 30, and opposite to each other, and two side walls 50, 52 located at opposite ends of the box in abutting relationship with the ends of the first, second, and third walls 30, 40, 42. The box 10 is further provided with a frame 55 positioned on the front of the box along the front edges of walls 40, 50, and 52. A door seal 60 is located on the frame 55 to ensure a tight seal and prevent leakage when the door 20 is closed.

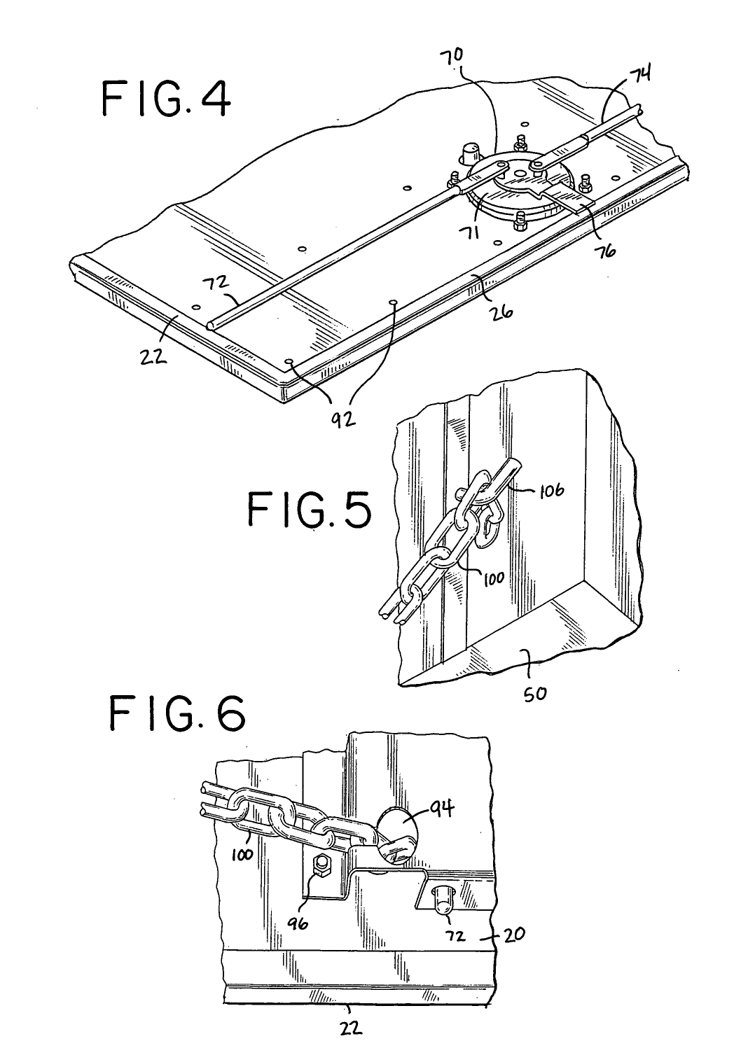

As shown in FIGS. 2 and 4, the box 10 includes a three-point latching mechanism 70 on the inside face 23 of the door 20. The latching mechanism 70 includes a circular rotary plate 71, arms 72 and 74, and latch 76. The rotary plate 71 is operatively coupled to a “D”-shaped handle 80 provided on the outer surface 21 of the door 20, as shown in FIG. 3.

When the “D”-shaped handle 80 is rotated, it in turn causes the rotary plate 71 to rotate. This rotation causes the latch 76 to move out of engagement with a lip 66 of the frame 55 and the free ends of the arms 72 and 74 to move out of engagement with lips 62 and 64 of the frame 55. Thus, with the latch 76 and the arms 72, 74 out of engagement with the lips of the frame, the user can open the door 20 and access the interior of the box.

Referring again to FIG. 2, the door 20 is further provided with a stiffener 90 mounted to the door 20 by fasteners 96 through mounting holes 92, as best seen in FIG. 4. The stiffener 90 functions to provide stiffness to the door 20 and is positioned over the three-point latching mechanism 70 on the inside face 23 of the door 20. The stiffener 90 is provided with receiving slots 94, one at each end. As will be described below, the slots 94 accommodate one end of members 100.

As best seen in FIG. 2, the door 20 is coupled to the remainder of the box by a hinge arrangement 98, which may be a single panel hinge or a plurality of hinges, and a plurality of adjustable linking members 100. The hinge arrangement is coupled to the door 20 by a plurality of bolts 110. This configuration allows for different doors to be installed by the user. For example, if the user desires a door constructed of a different material or finish, the existing door can be easily replaced since it is merely bolted onto the walls of the box.

In the preferred embodiment, the adjustable linking members 100 comprise chains. A first end 102 of each chain 100 is connected to the adjacent side wall 50, 52 by a hook 106, as seen in FIG. 5. The user can adjust the opening of the door 20 by slipping a different chain link over the hook 106, thereby shortening the chain 100 and allowing the door 20 to open at any angle varying between 0° and 95°. A second end 104 of each chain 100 is connected to the inside of the door 20 at the receiving slot 94, as shown in FIG. 6. The desired link of the chain 100 is placed within slot 94. The second end 104 of the chain is adjustable by allowing different links of the chain 100 to be inserted into the receiving slot 94.

The first end 102 and second end 104 of the chains 100 can be completely un-latched from the hooks 106. Thus, the door 20 can be opened at any angle from 0° to 180°. With the door 20 completely in the 180° position, the user can easily load or unload large size items or odd-dimensioned items from the box with no interference from the door 20. Thus, this feature gives the user greater flexibility with respect to the size and orientation of objects that can be stored in the box, as the objects are not limited by the size of a set opening.

The walls 30, 40, 42, 50, and 52 of the underbed box are made of steel, a highly durable metal, to ensure that the box will be able to withstand any type of extreme situation, including bumpy roads and rough treatment by the user. The door 20, however, is constructed of aluminum, with stainless steel bolts and hinges used to fasten the door 20 to the edge of the second wall 30. The use of the aluminum material for both the door and the fasteners eliminates the fabrication issue of bare metal surfaces, which are normally susceptible to corrosion. The combination of the aluminum door and steel walls enhances the strength and durability of the box, while also helping to protect the box from corrosion when it is hauled through inclement weather, including rain and snow.

While certain features and embodiments of the present invention have been described in detail herein, it is to be understood that the invention encompasses all modifications and enhancements within the scope and spirit of the following claims.

We claim:

1. An underbed box for a truck comprising:
a door;
a first wall located opposite the door;
second and third walls positioned between the door and the first wall, and opposite to each other;
two side walls located at opposite ends of the box in abutting relationship with the ends of the first, second, and third walls; and
the door being mounted to an edge of the second wall by a hinge and to the side walls by a plurality of linking members;
wherein the linking members are adjustable to allow the door to open at any angle varying between 0° and 95°, and removable to allow the door to open at any angle from 0° to 180°.

2. The underbed box of claim 1 wherein a stiffener is mounted to the door, the stiffener including receiving slots.

3. The underbed box of claim 2 wherein the plurality of linking members comprise a plurality of chains.

4. The underbed box of claim 3 wherein the plurality of chains comprise two chains, each having a first end and a second end.

5. The underbed box of claim 4 wherein the first end of each chain is connected to an adjacent side wall by a hook, and the second end of each chain is connected to the door by the receiving slots on the stiffener.

6. The underbed box of claim 5, wherein the first end of the chain is adjustable.

7. The underbed box of claim 5, wherein the second end of the chain is adjustable.

8. The underbed box of claim 1 wherein the door has a latching mechanism that latches the door in a closed position.

9. The underbed box of claim 8 wherein the latching mechanism is located on an inside face of the door, the latching mechanism including two arms and a latch operatively coupled to a circular rotary plate.

10. The underbed box of claim 1 wherein the walls of the box are constructed of steel and the door is constructed of a corrosion resistant material.

11. The underbed box of claim 10 wherein the corrosion resistant material is aluminum.

12. An underbed box for a truck comprising:
a door;
a first wall located opposite the door;
second and third walls positioned between the door and the first wall, and opposite to each other;
two side walls located at opposite ends of the box in abutting relationship with the ends of the first, second, and third walls; and
the door being mounted to an edge of the second wall by a hinge and to the side walls by a plurality of chains;
wherein the chains are adjustable to allow the door to open at any angle varying between 0° and 95°, and removable to allow the door to open at any angle from 0° to 180°.

13. The underbed box of claim 12 wherein a stiffener is mounted to the door, the stiffener including receiving slots.

14. The underbed box of claim 13 wherein the plurality of chains comprises two chains, each having a first end and a second end.

15. The underbed box of claim 14 wherein the first end of each chain is connected to an adjacent side wall by a hook, and the second end of each chain is connected to the door by the receiving slots on the stiffener.

16. The underbed box of claim 15 wherein the first end of the chain is adjustable.

17. The underbed box of claim 15 wherein the second end of the chain is adjustable.

18. The underbed box of claim 12 wherein the door further comprises a latching mechanism that latches the door in a closed position.

19. The underbed box of claim 18 wherein the latching mechanism is located on an inside face of the door, the latching mechanism including two arms and a latch operatively coupled to a circular rotary plate.

20. The underbed box of claim 12 wherein the walls of the box are constructed of steel and the door is constructed of a corrosion resistant material.

21. The underbed box of claim 20 wherein the corrosion resistant material is aluminum.
